(19) United States
(12) Patent Application Publication
(10) Pub. No.: US 2007/0151580 A1
(43) Pub. Date: Jul. 5, 2007

(54) Robot system and method for cathode washing in industrial and electrometallurgical processes

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/598,121

(22) Filed: Nov. 13, 2006

Related U.S. Application Data
(60) Provisional application No. 60/734,966, filed on Nov. 10, 2005.

(51) Int. Cl. B08B 7/04; B08B 3/00

(52) U.S. Cl. 134/18; 134/56 R; 134/61

(57) ABSTRACT

At present, cathode washing presents some disadvantages such as the fact the fixed nozzles impact all the face with the same strength and the range is limited, among other things.

A robot system and robotic method for the automatic washing of cathodes have been developed. The robotic system is composed mainly of a robotic manipulator (1) of at least 6 degrees of freedom and a gripping mechanism (2) which allows to take a pressurized hot water and/or vapor injection device (3), from a tool holder rack located at one of its sides, by moving it through a defined path to the washing unit, where in a synchronized way with the take off carousel the washing process will take place, in a sequential and programmed way through the application of pressurized hot water and/or vapor to a number of cathodes faces to be defined (4). In this regard, the washing of cathodes will be carried out by using a robotic system which will be connected to the existing pressure vapor and hot water lines.

### CROSS-REFERENCE TO RELATED APPLICATIONS

This application claims the benefit of provisional patent application Ser. No. 60/734,966 filed Nov. 10, 2005 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry to improve the washing cathodes, specifically in the electro winning area.

2. Prior Art

The electrodeposition process is one of the current and simplest methods to recover, in a pure and selective way, the metals in a solution. This process mainly uses the permanent cathode technology, which consists in depositing the metal in tanks where they remain for a certain period of time and through an electrometallurgical process the metal in the solution starts to adhere to the walls of the base plate until reaching a determined weight. Once the weight is reached, the cathodes are removed (harvest) through an operation carried out with a bridge crane which takes a volume of the cathodes of each cell and moves it to the washing tunnel

In this operation, an initial washing of the cathodes on the cells is performed which is intended to remove the remains of copper and organic material from the cathode surface. In this stage, water and vapor is used through fixed nozzles which propel water and vapor on the cathode faces. After the washing tunnel is passed they reach the stripping area.

The disadvantages of the actual method of cathodes washing are:
The personnel for washing are subjected to a high physical demand and harsh environmental conditions.
The fixed nozzles can not impact all the face with the same strength.
The range is limited by the disposition.
Any optimization being made to the nozzle implies to stop the machine.
The maintenance tasks are difficult due to room space problems.

### SUMMARY

A robotic system and a robotized method have been developed for washing the cathodes in an automated way to avoid sulphure deposits over the cathode surface.

### DRAWINGS—FIGURES

In the drawings, closely related figures share the same numbers, with different alphabetic suffixes.

FIG. 1. View of the robotic manipulator washing the cathode

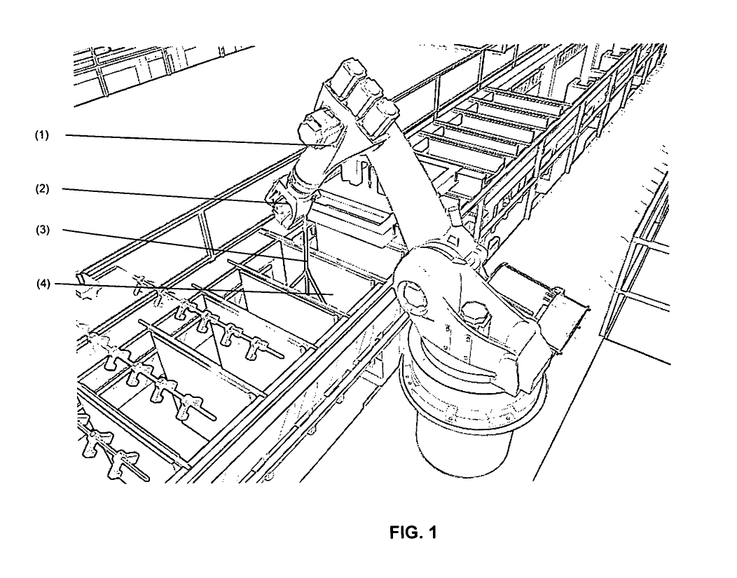

FIG. 2. View of the robotic manipulator washing the cathode.

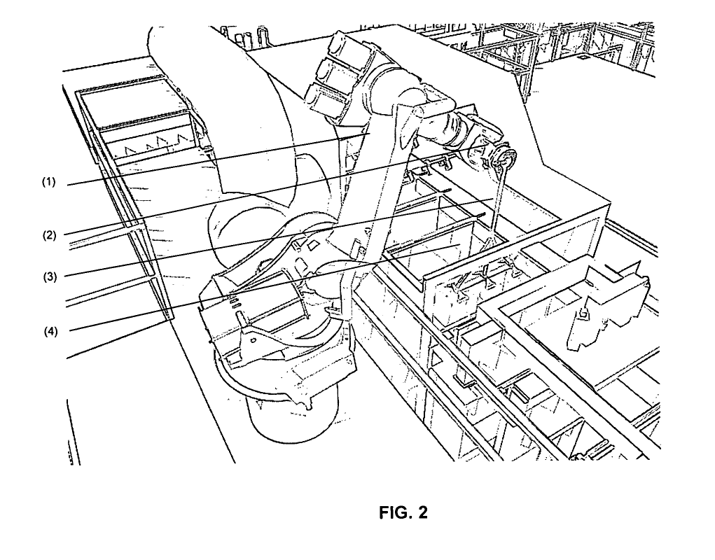

### DRAWINGS—REFERENCE NUMERALS

1. Robotic manipulator

2. Gripping mechanism

3. Pressurized hot water and/or vapor injection device

4. Cathodes Chain conveyor

### DETAILED DESCRIPTION

This invention relates to a new robot system as well as a robotic method for washing the cathodes which is carried out automatically through anthropomorphous robotic arms of at least 5 degrees of freedom, which are installed at one side of the washing station.

With reference to FIGS. N^{o} 1 and 2, the robot system is composed mainly of one robotic manipulator (1) of at least 5 degrees of freedom, provided with a communication, acquisition and control system, and a gripping mechanism (2) to allow to take a pressurized hot water and/or vapor injection device (3), from a tool holder rack located at one of its sides, moving it through a defined path to the washing station, where it will be synchronized with the take off carousel and will carry out a washing process, in a sequential and programmed way through the application of pressurized hot water and/or vapor to a number of cathode faces to be defined (4). In this way, the washing of cathodes will be carried out through the use of a robotic system which is connected to the existing vapor and/or pressure water lines.

I claim:

1. A robot system for the washing of cathodes in electrometallurgical and industrial processes comprising an anthropomorphous robotic arm of at least 5 degrees of freedom, one control, communication and programming unit, one gripper adapter, one pneumatic gripper, its fingers, one pneumatic gripper driving system, one electric supply system, a pressurized hot water and/or vapor injection device and a tool holder, wherein the anthropomorphous robotic arm of at least 5 degrees of freedom is provided with a gripping mechanism which allows to take, from a tool holder rack, a pressurized hot water and/or vapor injection device, which is used to carry out the washing process, in a sequential and programmed way, through the application of pressurized hot water and/or vapor jets to a number of faces of cathodes to be defined.

2. Robotic system for the washing of cathodes in electrometallurgical and industrial processes according to claim 1, wherein the anthropomorphous robotic arm of at least 5 degrees of freedom is provided with a pneumatic gripping mechanism which allows to take, manipulate and release a pressurized hot water and/or vapor injection device in order to wash the cathode surfaces in different paths within the work volume of the robotic system in an automated way.

3. Robotic system for the washing of cathodes in electrometallurgical and industrial processes according to claim 1, wherein the anthropomorphous robotic manipulator of at least 5 degrees of freedom is mounted on a fixed and/or mobile support located at one side of the productive line of a electrometallurgical or industrial process.

4. Robotic system for the washing of cathodes in electrometallurgical and industrial processes according to claim 1, wherein the anthropomorphous robotic manipulator can communicate by itself or through a PLC interface with the control system of the ISA process as well as with the Kidd process.

5. Robotic system for the washing of cathodes in electrometallurgical and industrial processes according to claim 1, wherein the anthropomorphous robotic manipulator has the capacity to obtain and interpret the information from analogue and/or digital sensors installed in the ISA process as well as from the Kidd process.

6. Robotic system for the washing of cathodes in electrometallurgical and industrial processes according to claim 1, wherein the anthropomorphous robotic manipulator has the capacity to generate analogue and/or digital signals to control analogue and/or digital input devices.

7. Robotic system for the washing of cathodes in electrometallurgical and industrial processes according to claim 1, wherein a gripping mechanism is used, in a sequential and programmed way which allows to take, manipulate and release a pressurized hot water and/or vapor injection device to wash the surfaces of a cathode.

8. Robotic system for the washing of cathodes in electrometallurgical and industrial processes according to claim 1, wherein a pressurized hot water and/or vapor injection device is used to wash a cathode which can be provided with at least 3 discharge outlets of hot water and/or vapor jets per each side, so as this discharge is used for washing procedures.

9. Robotic system for the washing of cathodes in electrometallurgical and industrial processes according to claim 1, wherein a pressurized hot water and/or vapor injection device is used to wash the surfaces of the cathodes in a way that it allows the washing of two surfaces of the cathodes at the same time.

10. Robotic system for the washing of cathodes in electrometallurgical and industrial processes according to claim 1, wherein it has a tool holder rack which is intended to contain the pressurized hot water and/or vapor injection device.

11. Robotic system for the washing of cathodes in electrometallurgical and industrial processes according to claim 1, wherein the pressurized hot water and/or vapor injection device is connected to the existing hot water and/or vapor lines.

12. Robotic system for the washing of cathodes in electrometallurgical and industrial processes according to claim 1, wherein it could be integrated electronically in the ISA process as well as in the Kidd process.

13. Robotic system for the washing of cathodes in electrometallurgical and industrial processes according to claim 1, wherein the anthropomorphous robotic manipulator has an electrical system driven by three-stage induction motors, with vectorial and/or scalar control.

14. Robotic system for the washing of cathodes in electrometallurgical and industrial processes according to claim 1, wherein it could be integrated not only to electrowinning process of different metals such as copper, zinc, but also it could also be used to carry out washing activities in a wide range of other industrial productive processes.

15. Robotic system for the washing of cathodes in electrometallurgical and industrial processes according to claim 1, wherein productivity and efficiency in the washing process increases.

16. Robotic system for the washing of cathodes in electrometallurgical and industrial processes according to claim 1, wherein it prevents the washing personnel from being subjected to a high physical demand and harsh environmental conditions.

17. Robotic system for or the washing of cathodes in electrometallurgical and industrial processes according to claim 1, wherein the system may operate automatically, or semiautomatically, and also allows solutions scalability.

18. Robotic method for the washing of cathodes in electrometallurgical and industrial processes using the robot System of claim 1 to 17, wherein the anthropomorphous robotic manipulator of at least 5 degrees of freedom is provided with a gripping mechanism which allows to take from a tool holder rack a pressurized hot water and/or vapor injection device which is used for the washing process, in a sequential and programmed way, through the application of pressure hot water and/or vapor jets to a number of cathode faces to be defined.

19. Robotic method for the washing of cathodes in electrometallurgical and industrial processes using the robot System of claim 1 to 17, wherein the anthropomorphous robotic arm of at least 5 degrees of freedom is provided with a pneumatic gripping mechanism which allows to take, manipulate and release a pressurized hot water and/or vapor injection device in order to wash the surfaces of a cathode in different paths within the work volume of the robotic system in an automated way.

20. Robotic method for the washing of cathodes in electrometallurgical and industrial processes using the robot System of claim 1 to 17, wherein the anthropomorphous robotic manipulator of at least 5 degrees of freedom could be mounted on a fixed and/or mobile support located at one side of the productive line of the electrometallurgical or industrial process.

21. Robotic method for the washing of cathodes in electrometallurgical and industrial processes using the robot System of claim 1 to 17, wherein a gripping mechanism is used which allows, in a sequential and programmed way, to take, manipulate and release a pressurized hot water and/or vapor injection device to wash the cathode surfaces.

22. Robotic method for for the washing of cathodes in electrometallurgical and industrial processes using the robot System of claim 1 to 17, wherein a pressurized hot water and/or vapor injection device is used to wash the surfaces of a cathode, which is provided with at least 3 discharge outlets of hot water and/or vapor jets per each side, so that this discharge is used for washing procedures.

23. Robotic method for the washing of cathodes in electrometallurgical and industrial processes using the robot System of claim 1 to 17, wherein a pressurized hot water and/or injection device is used to wash the surfaces of a cathode in a way that it allows the washing of two surfaces of the cathodes at the same time.

24. Robotic method for the washing of cathodes in electrometallurgical and industrial processes using the robot System of claim 1 to 17, wherein it has a tool holder rack which is intended to contain the pressurized hot water and/or vapor injection device.

25. Robotic method for the washing of cathodes in electrometallurgical and industrial processes using the robot System of claim 1 to 17, wherein the pressurized hot water and/or vapor injection device is connected to the existing pressure hot water and/or vapor injection device lines.

26. Robotic method for the washing of cathodes in electrometallurgical and industrial processes using the robot System of claim 1 to 17, wherein it could be integrated electronically to the ISA process as well as in the Kidd process.

27. Robotic method for the washing of cathodes in electrometallurgical and industrial processes using the robot System of claim 1 to 17, wherein the anthropomorphous robotic manipulator could communicate by itself or through a PLC interface with the control systems from the ISA process as well as from the Kidd process.

28. Robotic method for the washing of cathodes in electrometallurgical and industrial processes using the robot System of claim 1 to 17, wherein the anthropomorphous robotic manipulator has the capacity to obtain and interpret the information of analogue and/or digital sensors installed in the ISA process as well as in Kidd process.

29. Robotic method for the washing of cathodes in electrometallurgical and industrial processes using the robot System claim 1 to 17, wherein the anthropomorphous robotic manipulator has the capacity to generate analogue and/or digital signals to control analogue and/or digital input devices.

30. Robotic method for the washing of cathodes in electrometallurgical and industrial processes using the robotic System of claim 1 to 17, wherein the anthropomorphous robotic manipulator has an electric supply system driven by induction cage motors (with no slip rings), with vectorial control.

31. Robotic method for the washing of cathodes in electrometallurgical and industrial processes using the robot System claim 1 to 17, wherein it could be integrated not only to electrowinning processes of different metals such as copper, zinc, but also it could be used to carry out washing processes in a wide range of other industrial productive processes.

32. Robotic method for the washing of cathodes in electrometallurgical and industrial processes using the robot System claim 1 to 17, wherein productivity and efficiency of the washing process increases.

33. Robotic method for the washing of cathodes in electrometallurgical and industrial processes using the robot System of claim 1 to 17, wherein it prevents the plant personnel from being subjected to a high physical demand and harsh environmental conditions.

34. Robotic method for the washing of cathodes in electrometallurgical and industrial processes using the robot System of claim 1 to 17, wherein the system may operate automatically or semiautomatically, and also allows solution scalability.
